(19) United States
(12) Patent Application Publication
(10) Pub. No.: US 2002/0063091 A1
(43) Pub. Date: May 30, 2002

(54) Cleaning device for commercial shortening cookers

(76) Inventor: Robert H. Lafleur, Fall River, MA (US)

Correspondence Address: Thomas E Workman Jr., Law Offices of Thomas Workman, 41 Harrison Street, Taunton, MA, 02780, US

(21) Appl. No.: 09/725,824

(22) Filed: Nov. 29, 2000

(51) Int. Cl. B01D 35/28

(52) U.S. Cl. 210/470

(57) ABSTRACT

Commercial cookers utilize hot shortening or oil in order to deep fry potatoes or other fried foods. Crumbs of breading materials and pieces of food must be frequently removed from the hot shortening, in order to keep the taste of cooked food fresh. This invention permits a restaurant or commercial kitchen to extend the life of a batch of shortening in such a cooker by removing breaded materials and pieces of food so that they do not burn and spoil the taste of cooked foods. The cleaning device is used to filter unwanted food substances in the bottom of the cooker, permitting the cooker to remain in service, and the shortening to remain fresher. The removed food substances are periodically discarded.

### BACKGROUND OF THE INVENTION

1. Field of the Invention

Commercial cookers which utilize hot shortening in order to deep fry foods use a significant quantity of shortening. Typical cookers use between fifty and one hundred fifty pounds of shortening, and the cost of refilling such a cooker can be over a hundred dollars. Commercial cookers are typically fitted with a drain, located so as to permit the draining of all shortening from the unit. Manufacturers recommend that whenever the buildup of food substances begins to impart a burned taste to the shortening, that the cooker be shut down, all shortening drained from the cooker, and the inside scrubbed out to remove all remaining food substances. When such commercial cookers are used to make french fried potatoes, this cleaning cycle may be performed at the end of the day. However, when a commercial cooker is used to cook seafood or other foods with a breaded coating, the cookers may require cleaning several times a day.

Most restaurants or commercial kitchens find that if they are to follow the manufacturer's process for cleaning their deep fry cookers, they must have multiple cooking units on hand so as to have at least one such unit always available to prepare food for waiting patrons. These restaurants also must bear the cost of replacing the shortening with new shortening, once the units are drained and cleaned. Filters are available to recycle the shortening, but their use does not address the time that the cooker is out of service when the shortening is removed and filtered. The claimed invention provides a device which can be used to remove a significant portion of the food scraps which accumulate in the bottom of such commercial cookers, and in so doing, extend the time that such cookers can operate without draining and cleaning. For many restaurants, the use of such a cleaning device permits the restaurant to operate with one cooker, instead of two, and saves significantly on the cost of shortening used to operate the commercial cookers.

2. Description of Prior Art

Devices known as “sifters” have been known in the culinary field for many years. Other culinary devices have been invented to permit the removal of one unwanted substance from another. For example, U.S. Pat. No. 2,572,524 teaches how to remove grease from hot soup by permitting the soup to pass through perforations in the device, while collecting the grease. This invention utilizes the principle that grease floats to the top and can be accumulated and then discarded or recovered. This device separates the grease from the food product, and is designed to pass the food to be consumed through the perforations.

U.S. Pat. No. 599,217 is a straining device for culinary purposes, and consists of a perforated plate with varying configurations of perforations, so that an appropriate configuration of perforations may be utilized to recover food materials from a liquid, as in boiled vegetables. The invention restrains food to be consumed, as opposed to recovering waste food materials, and is designed to be used with a round pot or pan.

U.S. Pat. No. 1,334,169 is a culinary spoon which provides the services of a colander or strainer. This invention provides a method of removing cooked food from a solution or from a cooking pot, by permitting the perforations to be sealed off in one configuration or selectively opened in order to permit liquid to flow through, in a second configuration. Like most colanders and strainers, the food restrained by the invention is removed in order to be eaten, whereas the invention claimed is intended to remove particles of food substance which are not to be eaten.

U.S. Pat. No. 2,522,343 is a kitchen utensil that permits a quantity of edible food material to be transported within a kitchen from one place to another, and then sifted so as to spread an even powdery layer upon other food being prepared. Designed to permit the transport of flour to a cooking project, and then to sift the flour upon the food being prepared, this utensil is not designed to remove one substance from another, but rather to transport and then dispense flour upon food being prepared.

U.S. Pat. No. 5,526,737 is a kitchen utensil to remove fat from broth, by collecting the fat which floats on top of a prepared soup or broth and pouring this fat into a separate container. This device functions on the principle that the fat will float, and may be separated once it passes into the utensil through a single orifice, and is thereby removed.

U.S. Pat. No. 5,272,786 is a household scraper designed to remove kitchen waste from a kitchen sink. It has a plurality of perforations which retain kitchen foods while permitting water to pass through, thereby retaining the kitchen waste, and permitting it to be quickly removed and thrown away.

U.S. Pat. No. 5,706,546 is a tool for scooping material from containers, and is designed to remove any semi-viscous, viscous or dry material from containers of various shapes and configurations. This invention has a distinctive curved shape to permit use in cylindrical containers as well as rectangular containers. In addition, it is designed to remove a single substance from a container, and has no ability to separate one substance from another.

To find a tool with a rectangular shape and flat sides, one looks to U.S. Pat. Nos. 231,659; 246,604; and 484,621. These patents describe new and useful methods of sifting ashes, so as to permit ashes to pass through a screen grate, or through a perforated plate. These devices have the function of removing large items from the ash, so as to pass through only the ashes from a stove or furnace.

U.S. Pat. No. 3,976,564 is a sifter designed for use with a metal detector, and permits soil to be separated and passed through a number of perforations, leaving behind any metal objects for which one is searching. The invention is equipped with a light, to illuminate the curved area of the scoop, thereby permitting the enhanced viewing of recovered materials.

U.S. Pat. No. 2,355,130 is a specially coated perforated ladle designed to recover molten magnesium from molten salt baths. The configuration and size of the perforations, as well as the iron coating on the ladle, facilitate the removal and recovery of molten magnesium. This patented invention is an example of how perforated ladle like devices have been patented to perform specific tasks.

U.S. Pat. No. 2,150,899 is a complex system for purifying minerals. One of the steps described utilizes a scoop, labeled FIG. 8b, which is shovel-like in appearance, has vertical sides, and a perforated lower plate. This component of the invention is designed to remove slag, or material that has a lower specific gravity, and the patented invention prohibits this scoop from reaching the bottom of the rounded edges of the purification basins, by means of rails which limit the depth to which the scoops may probe.

Prior art exists in the fields of culinary tools, ash purification, soil scoops, metallurgy, and mineral purification. Culinary tools are typically too small, and ash purification tools too large, to effectively solve the problem at hand. Simply scaling the size of the tools does not present a solution to the problems solved by the invention. Tools for the sifting of soil, the purification of metals, or the purification of minerals are not likely to be applied to the cleaning of deep fry cookers, and the technology of such tools is not applicable to the problem of removing pieces of foods from large commercial cookers.

### SUMMARY OF THE INVENTION

The invention has a long handle made of a thermal resistant material, attached to a rectangular scoop which has a series of perforations to permit the flow of hot shortening through the bottom of a box-like container, thereby filtering out pieces of food, and permitting hot shortening to pass through the device. The scoop has a rectangular opening which is elongated, so that the uppermost part of the opening is never submerged in the hot shortening, insuring that the handle is never exposed to the hot shortening. When the device is scraped against the bottom of a commercial cooker, between the heating fins, pieces of food are trapped in the cleaning device, and may be removed from the hot shortening. The removal of pieces of food from the bottom of a commercial cooker prolongs the life of the hot shortening, increases the useful life of the hot shortening, and reduces the time the cooker must be taken out of service for cleaning. The invention also improves the taste of food cooked, by removing pieces of food which would otherwise burn and impart an unpleasant taste to the food prepared in the cooker.

### DESCRIPTION OF THE PREFERRED EMBODIMENT

In the preferred embodiment, the cleaning device 1 consists of a handle 2 and a basket 3. The handle 2 is constructed of wood, and is constructed so as to resemble the handle of an oar that would be used to row a small boat. The handle is nominally three feet in length, and is of a scale that permits an adult operator to gain leverage in puling the basket 3 through the hot shortening, utilizing the handle 2. The basket 3 is constructed of stainless steel, and consists of a perforated bottom plate 4, a left side plate 5, a right side plate 6, a far end plate 7, and a close end plate 8. The two side plates 5, 6 are mirror images of one another, and are two feet in length, a length that is sufficient to permit the basket 3 to be utilized in a cooker with hot shortening filled to a deapth of less than two feet. The perforated bottom plate 4 is made of a traditional perforated stainless steel, which may be obtained already fabricated with nominal one eight inch holes placed at a distance of approximately one quarter inch apart.

The left side plate 5 is welded to the far end plate 7, which is in turn welded to the right side plate 6, which is in turn welded to the close end plate 8, which in turn is welded to the left side plate 5, so as to form a rectangular box structure with wing like extensions 9, without a bottom. The perforated bottom plate 4 is then welded to the rectangular box to form a basket assembly 10.

In the preferred embodiment, the handle 2 is approximately three feet long, and the basket 3 is approximately twenty-six inches long, one inch wide, seven inches deep at the far end, and three and a half inches deep at the end attached to the handle 2. The handle 2 is made of a hardwood, and the metallic parts are all stainless steel.

The handle 2 is attached to the basket assembly 10 by means of placing the end of the handle 2 between the wing like extensions 9 of the basket assembly 10, and utilizing traditional fasteners 11. In the preferred embodiment, the fasteners consist of three stainless steel bolts 12, a pair of washers 13, a pair of lockwashers 14, and two nuts 15. The bolts 12 are nominally a one quarter inch bolt of a length sufficient to pass through the washer 13, wing like extension 9, handle 2, wing like extension 9, lockwasher 14, and nut 15.

The cleaning device is used in conjunction with a commercial cooker and food baskets designed to hold food when they are immersed into hot shortening held by the commercial cooker. These commercial cookers are traditionally fueled by natural gas or propane. The commercial cooker, food basket, and method of cooking fried foods are explained so as to understand the context in which the cleaning tool operates, but none of these are claimed as part of the claimed invention.

The cleaning device 1 is shown being used with a commercial cooker 16, and demonstrates how the cleaning device 1 passes between the heating elements 17 of the cooker 16. The heating elements 17 consist of an outer protective shell 18 and an inner burner assembly 19. A flame 20 from the burner assembly creates heat against the protective shell 18, heating the shortening 21 in the cooker 16. There are a plurality of heating elements 17 configured at a distance of several inches apart, near the bottom of the cooker 16.

Once the shortening 21 is heated, food 23 is placed in a food preparation basket 22 and immersed into the hot shortening 21. If the food being cooked 23 is breaded with a flour or cornmeal breading, small bits of the food being cooked 24, along with particles of breading material 24, are dislodged and fall to the bottom of the cooker 16. If these food particles 24 are not removed, they will burn and impart a burned taste to the hot shortening 21, which in turn will spoil the taste of food 23 which is being prepared.

The dimensions on the basket assembly 10, from the outer most edge of the left side plate 5 to the outer most edge of the right side plate 6 is configured to be a three eights of an inch less than the distance between heating elements 17 in the cooker, so that the basket assembly 10 can pass easily between two of the heating elements 17, when moved in a parallel direction to the orientation of the heating elements 17.

When the cleaning device is used, the food preparation basket 22 is removed from the cooker 16. The cleaning device 1 is placed into the hot shortening 21, so that the far end plate 7 of the cleaning device 1 makes contact with the bottom of the cooker 25. The cleaning device 1 is then moved in a continuous sweeping motion, so that the perforated bottom plate accumulates unwanted food particles 24, which are trapped between the side edges of the basket, and held in place by the flow of hot shortening which passes through the perforations in the bottom plate 4. The cleaning device 1 is removed from the hot shortening 21, and is held above the hot shortening 21 to permit the basket 3 to drain. The food particles 24 removed are then discarded by inverting the basket so that the basket 3 is pointed downwards into a container 26 intended to collect the discarded food particles 24. The basket 3 may be gently shaken in order to dislodge particles 24 that are trapped in the basket.

After use, the cleaning device may be scrubbed with soap and hot water, or may be sterilized with steam or boiling water. The stainless steel construction of the basket 3 and hardwood handle 2 facilitate cleanliness and sanitation associated with cooking of food. The invention is configured so that the handle 2 is seldom immersed in hot shortening 21, thereby placing only stainless steel components into the hot shortening, which can be sterilized to insure cleanliness and to insure the purity of the hot shortening, and of the food cooked therein. The handle 2 may be periodically replaced, utilizing traditional hardwood handles 2 with dimensions appropriate to the cleaning device. The handle 2 can be removed to permit the stainless steel basket 3 to be sterilized, and then reattached to the handle 2 using the traditional fasteners 11.

### BRIEF DESCRIPTION OF THE DRAWINGS

FIG. 1 shows the invention in perspective.

FIG. 2 shows a cutaway view of the basket portion of the invention.

FIG. 3 shows the method of attaching the basket portion of the invention to the handle.

FIG. 4 shows the invention being used with a commercial cooker.

FIG. 5 shows the invention being emptied after materials have been removed from a commercial cooker.

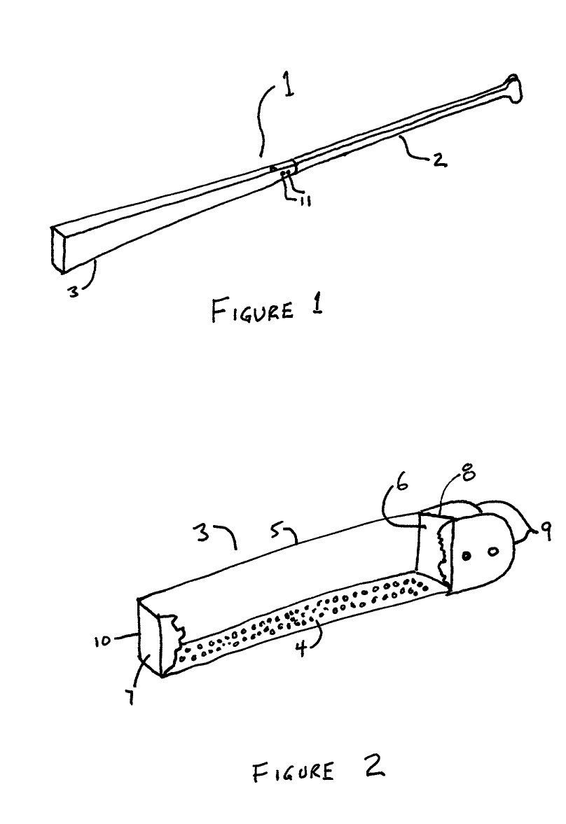

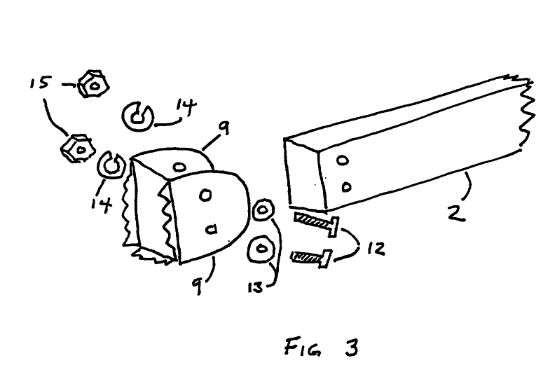

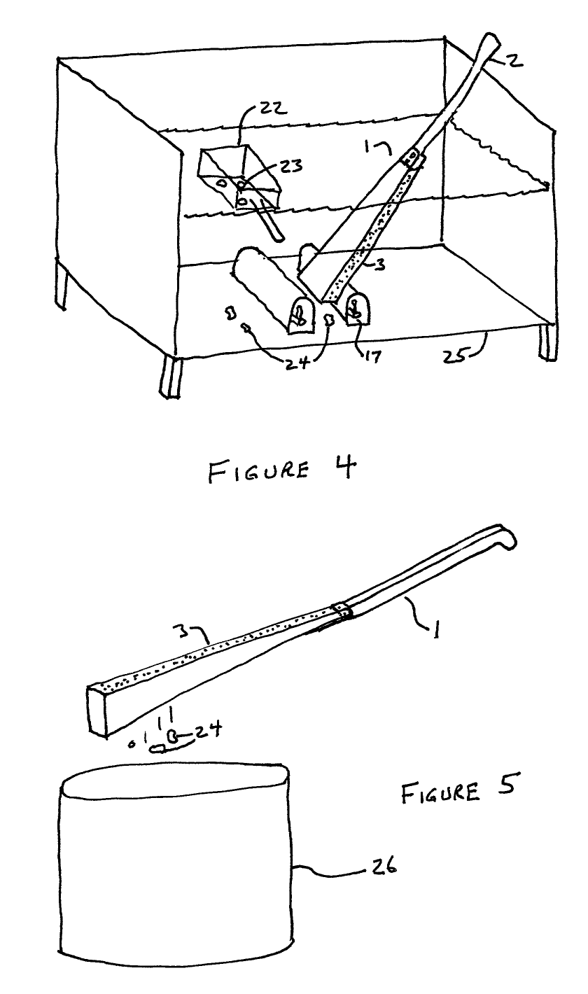

I claim:

1. A cleaning device for removing scraps of food from the bottom of a commercial cooker in which food is deep fried, said cleaning device consisting of:
A. A basket, said basket consisting of a left side, a right side, a far end, a near end, and a bottom, all made of a material that can be easily cleaned and which will not deform when subjected to temperatures of four hundred degrees fahrenheit,
i. Said left side being flat and having a shape that contains two right angles, the length of said left side being defined by an edge that has a right angle at each end of said edge, being of a length that is longer than the nominal deapth of hot shortening that is to be in said commercial cooker to be cleaned, a dimension that is greater than twenty-four inches,
ii. Said right side being flat and of the same shape and dimensions in length and width as said left side,
iii. Said far end being flat and rectangular, and having a width that is the same as that of the left side and the right side, being four to nine inches in width, said far end being attached along its width to the left side along one width edge, and being attached along the opposite width edge to the right side, so as to separate the left side from the right side by two to four inches, said attachments forming a right angle between the right side and the far end, and a right angle between the left side and the far end,
iv. Said near end being flat and rectangular, having a width and length that is smaller than those of the the far end, said near end being attached along its width to the left side along one width edge, and being attached along the opposite width edge to the right side, said attachments forming a right angle between the right side and the far end, and a right angle between the left side and the far end,
v. Said bottom being flat and rectangular, having the same length as the length of the right side and of the left side, and the same width as the length of the far end and of the near end, said bottom being attached along the edges to the edges of the assembled left side, far end, right side, and near end, so as to form an open box structure ,
vi. Said bottom being made of a perforated material;
B. A handle,
i. Said handle being made of a material that is not a good conductor of heat, and which remains rigid when subjected to temperatures of four hundred degrees fahrenheit,
ii. Said handle being two to four feet in length,
iii. Said handle having a rounded end, similar to that of a boat oar, said rounded end being configured to provide a comfortable grip when grasped by a human operator,
iv. Said handle having a connecting end with two flat surfaces, said flat surfaces being parallel to and opposite one another, and said flat surfaces being separated by a distance that is equal to the inside dimension of the open box structure which forms said basket;
C. A connecting mechanism,
i. Said connecting mechanism consisting of two wings,
a. One of said wings being attached to the right side and the other wing being attached to the left side, so as to form an extension to the box structure from the near end portion of the box structure,
b. One of said wings being attached in the same plane as the left side, and the other wing in the same plane as the right side, together forming a slot into which the handle may be inserted for attachment,
c. One or more holes through said wings, aligned with an equal number of holes through the handle,
d. One or more fasteners which pass through the aligned holes in order to affix the wings to the handle, thereby attaching the basket to the handle by means of the wings.

2. A cleaning device as in claim 1, wherein the basket, wings, and connecting materials are made of stainless steel.

3. A cleaning device as in claim 1, wherein the handle is made of wood, said wood selected from the family of trees known as hardwood.

4. A cleaning device as in claim 1, wherein the basket, wings, and connecting materials are made of stainless steel, the basket is twenty five inches in the longest dimension, the handle is made of oak and is three feet long, there are three connecting mechanisms which are quarter inch bolts, with washers, lockwashers, and nuts, and the perforations in the bottom of the basket are one-eighth of an inch.
